(19) United States
(12) Patent Application Publication
(10) Pub. No.: US 2013/0128697 A1
(43) Pub. Date: May 23, 2013

(54) Downhole Communication System

(71) Applicants: Erwann Lemenager, Paris (FR); David Merlau, Friendswood, TX (US); Amit Mohan, Rosharon, TX (US)

(72) Inventors: Matthe Contant, Le Plessis Robinson (FR); Erwann Lemenager, Paris (FR); David Merlau, Friendswood, TX (US); Amit Mohan, Rosharon, TX (US)

(21) Appl. No.: 13/518,389

(22) PCT Filed: Dec. 27, 2010
(86) PCT No.: PCT/US10/62164

§ 371 Date: Feb. 6, 2013

Related U.S. Application Data
(60) Provisional application No. 61/290,328, filed on Dec. 28, 2009.

(51) Int. Cl. G01V 3/18

(52) U.S. Cl. CPC G01V 3/18
USPC 367/81

(57) ABSTRACT

A downhole communication system and method is presented for communicating between a downhole location within a wellbore and a surface location. The system preferably comprises a first and second telemetry module, a downhole tool, and an interface electrically connecting the downhole tool to the first and second telemetry modules. The first telemetry module is connected to a string and positioned downhole within the wellbore, and configured to receive communication signals via acoustic propagation or low frequency electromagnetic transmission. The second telemetry module is connected to the string and positioned downhole within the wellbore, and configured to receive communication signals via fluid pressure pulse commands. The downhole tool is operatively connected to the string. And the interface is adapted to selectively relay digital communication signals between the downhole tool and at least one of the first and second telemetry modules.

### CROSS-REFERENCE TO RELATED APPLICATION

The present application is based on and claims priority to U.S. Provisional Patent Application No. 61/290,328, entitled “DUAL DOWNHOLE COMMUNICATION SYSTEM,” filed Dec. 28, 2009.

### TECHNICAL FIELD

The present disclosure relates, in general, to wireless telemetry systems for use with installations in oil and gas wells or the like. More particularly, but not by way of limitation, the present disclosure relates to a downhole communication system and apparatus for bi-directional communication between a location down a borehole and the surface, or between downhole locations themselves.

### BACKGROUND

One of the more difficult problems associated with any borehole is to communicate measured data between one or more locations down a borehole and the surface, or between downhole locations themselves. For example, in the oil and gas industry it is desirable to communicate data generated downhole to the surface during operations such as drilling, perforating, fracturing, and drill stem or well testing; and during production operations such as reservoir evaluation testing, pressure and temperature monitoring. Likewise, communication is also desired for transmitting intelligence from the surface to downhole tools, equipment, or instruments to effect, control or modify operations or parameters.

Accurate and reliable downhole communication is particularly important when complex data comprising a set of measurements or instructions is to be communicated, i.e., when more than a single measurement or a simple trigger signal has to be communicated. For the transmission of complex data it is often desirable to communicate encoded digital signals.

Downhole formation testing, like other investigation techniques, is traditionally performed in a “blind fashion”: downhole tools and sensors are deployed in a well at the end of a tubing string for several days or weeks after which they are retrieved at surface. During the downhole testing operations, the sensors may record measurements that will be used for interpretation once retrieved at surface. It is only after the downhole testing tubing string is retrieved that the operators will know whether the data are sufficient and not corrupted. Similarly when operating some of the downhole testing tools from surface, such as tester valves, circulating valves, packer, samplers or perforating charges, the operators do not obtain a direct feedback from the downhole tools.

In these types of downhole testing operations, the operator can greatly benefit from having an accurate and reliable means to Communicate with the downhole testing tools, and would also benefit from a two-way communication between surface and downhole. One approach which has been widely considered for borehole communication is to use a direct wire connection between the surface and the downhole location(s). Communication then can be made via electrical signal through the wire. While much effort has been spent on “wireline” communication, its deployment can pose problems for some downhole operations since using a cable since inside the tubing string limits the flow diameter and requires complex structures to pass the cable from the inside to the outside of the tubing, and space outside the tubing is limited leaving a cable vulnerable to being damaged. A cable inside the tubing is also an additional complexity in case of emergency disconnect for an offshore platform.

Wireless communication systems have also been developed for purposes of communicating data between a downhole tool and the surface of the well. These techniques include, for example, communicating commands via (1) electromagnetic waves; (2) pressure or fluid pulses; and (3) acoustic communication. A number of proposals have been made for wireless telemetry systems based on acoustic and/or electromagnetic communications. Examples of various aspects of such systems can be found in: U.S. Pat. No. 5,050,132; U.S. Pat. No. 5,056,067; U.S. Pat. No. 5,124,953; U.S. Pat. No. 5,128,901; U.S. Pat. No. 5,128,902; U.S. Pat. No. 5,148,408; U.S. Pat. No. 5,222,049; U.S. Pat. No. 5,274,606; U.S. Pat. No. 5,293,937; U.S. Pat. No. 5,477,505; U.S. Pat. No. 5,568,448; U.S. Pat. No. 5,675,325; U.S. Pat. No. 5,703,836; U.S. Pat. No. 5,815,035; U.S. Pat. No. 5,923,937; U.S. Pat. No. 5,941,307; U.S. Pat. No. 5,995,449; U.S. Pat. No. 6,137,747; U.S. Pat. No. 6,147,932; U.S. Pat. No. 6,188,647; U.S. Pat. No. 6,192,988; U.S. Pat. No. 6,272,916; U.S. Pat. No. 6,320,820; U.S. Pat. No. 6,321,838; U.S. Pat. No. 6,912,177; EP0550521; EP0636763; EP0773345; EP1076245; EP1193368; EP1320659; EP1882811; WO96/024751; WO92/06275; WO05/05724; WO02/27139; WO01/39412; WO00/77345; WO07/095111.

Likewise, systems for operating a downhole tool via pressure pulses are disclosed in U.S. Pat. No. 4,796,699, titled “WELL TOOL CONTROL SYSTEM AND METHOD,” which teaches operating a series of valves to selectively communicate the bore and annulus pressures to either add positive pressure pulses to returning drilling mud (positive pulse telemetry) or to add negative pressure pulses to returning drilling mud (negative pulse telemetry).

Each of these wireless communication systems provide certain benefits, and inherently comprise certain limitations. It is therefore desirable to provide a downhole communication system that offers a redundancy in wireless communication means for reliably controlling downhole tools. In addition, it would be desirable to provide a mechanism for sending direct feedback to the surface regarding the status of a downhole tool.

### BRIEF SUMMARY OF THE DISCLOSURE

In one aspect, one or more embodiments of the present disclosure relates to a downhole communication system for communicating between a downhole location within a wellbore and a surface location. The system preferably comprises a first and second telemetry module, a downhole tool, and an interface electrically connecting the downhole tool to the first and second telemetry modules. The first telemetry module is connected to a string and positioned downhole within the wellbore, and configured to receive communication signals via acoustic propagation and/or low frequency electromagnetic transmission. The second telemetry module is connected to the string and positioned downhole within the wellbore, and configured to receive communication signals via fluid pressure pulse commands. The downhole tool is operatively connected to the string. And the interface is adapted to selectively relay digital communication signals between the downhole tool and at least one of the first and second telemetry modules.

In another aspect, one or more embodiments of the present disclosure relates to an interface connected to a string and positioned downhole within a wellbore. The interface is preferably configured to facilitate communication between a downhole location within a wellbore and a surface location. The interface preferably comprises an electronic module electrically connecting a downhole tool to a first telemetry module and a second telemetry module. The first telemetry module is configured to receive communication signals via at least one of acoustic propagation and low frequency electromagnetic transmission, and the second telemetry module is configured to receive communication signals via fluid pressure pulse commands. The electronic module of the interface preferably comprises at least one microcontroller executing instructions to selectively relay digital communication signals from at least one of the first telemetry module and second telemetry module to the downhole tool.

In yet another aspect, one or more embodiments of the present disclosure relates to a method for communicating between a downhole location within a wellbore and a surface location. The method preferably comprises the steps of (1) initiating a communication signal at a surface location, wherein the communication signal comprising at least one of a fluid pressure pulse command, a low frequency electromagnetic transmission, and an acoustic propagation; (2) receiving the communication signal at a first telemetry module or a second telemetry module connected to a string and positioned downhole within the wellbore, wherein the first telemetry module is configured to receive communication signals via at least one of acoustic propagation and low frequency electromagnetic transmission, and the second telemetry module is configured to receive communication signals via fluid pressure pulse commands; (3) decoding the communication signal at the first telemetry module or second telemetry module to create a digital communication signal; and (4) selectively relaying the digital communication signal at an interface between a downhole tool and at least one of the first and second telemetry modules.

These together with other aspects, features, and advantages of the present disclosure, along with the various features of novelty, which characterize the invention, are pointed out with particularity in the claims annexed to and forming a part of this disclosure. The above aspects and advantages are neither exhaustive nor individually or jointly critical to the spirit or practice of the disclosure. Other aspects, features, and advantages of the present disclosure will become readily apparent to those skilled in the art from the following detailed description in combination with the accompanying drawings. Accordingly, the drawings and description are to be regarded as illustrative in nature, and not restrictive.

### BRIEF DESCRIPTION OF DRAWINGS

Implementations of certain aspects of the invention may be better understood when consideration is given to the following detailed description thereof. Such description makes reference to the annexed pictorial illustrations, schematics, graphs, drawings, and appendices. In the drawings:

FIG. 1 shows a drill pipe with a downhole wireless telemetry system in accordance with one or more embodiments of the present disclosure;

FIG. 2 shows an interface for controlling a downhole tool in accordance with one or more embodiments of the present disclosure;

FIG. 3A shows a schematic flow chart illustrating control of a downhole tool in accordance with one or more embodiments of the present disclosure;

FIG. 3B shows a schematic diagram illustrating control of a downhole tool in accordance with one or more embodiments of the present disclosure;

FIG. 4 depicts a schematic illustration of a drill string with a downhole wireless telemetry system in accordance with one or more embodiments of the present disclosure; and

FIG. 5 shows an interface and an exemplary protective cover for an interface for controlling a downhole tool in accordance with one or more embodiments of the present disclosure.

### DETAILED DESCRIPTION

Specific embodiments of the present disclosure will now be described in detail with reference to the accompanying Figures. Like elements in the various Figures are denoted by like reference numerals for consistency.

In the following detailed description of embodiments of the present disclosure, numerous specific details are set forth in order to provide a more thorough understanding of the present disclosure. However, it will be apparent to one of ordinary skill in the art that the present disclosure may be practiced without these specific details. In other instances, well-known features have not been described in detail to avoid unnecessarily complicating the description.

In general, embodiments of the present disclosure provide methods and apparatuses for communicating between a location downhole and the surface, or between downhole locations themselves. More specifically, embodiments of the present disclosure relate to dual control of downhole testing and circulating valves, downhole sampling tools, downhole packers, downhole firing heads or any other remotely operated downhole tool. The operation of “valves” will be explained in more detail hereinafter, however, it should be understood by a person skilled in the art that the operation of other downhole tools and instruments may be controlled in a similar manner. Furthermore, wireless telemetry as discussed herein may include electromagnetic transmission, acoustic propagation, and fluid pressure pulse commands. Where a specific type of wireless communication is discussed in detail with reference to a specific example, it should be understood that other types of wireless telemetry may be used interchangeably without undue effort or experimentation by a person of ordinary skill in the art.

Dual control of a downhole tool may be obtained by enabling communication between at least two downhole telemetry modules. The first telemetry module may be a wireless remote telemetry system using electromagnetic transmission or acoustic propagation to wirelessly communicate with downhole testing tools. The second telemetry module may be connected to the drill string and operated using fluid pressure pulse commands. Again, it should be noted that the second telemetry module may be a variety of downhole tools, and may be a valve control tool as described hereinbefore connected to, for example, testing and circulating valves. The communication between the aforementioned wireless telemetry system and downhole tool may be enabled using an electromechanical interface. In one or more embodiments of the present disclosure, the interface can be embedded into both the first and second telemetry modules. Further, embodiments of the present disclosure relate to methods and apparatus to provide feedback regarding the status of the downhole tool using the wireless telemetry system.

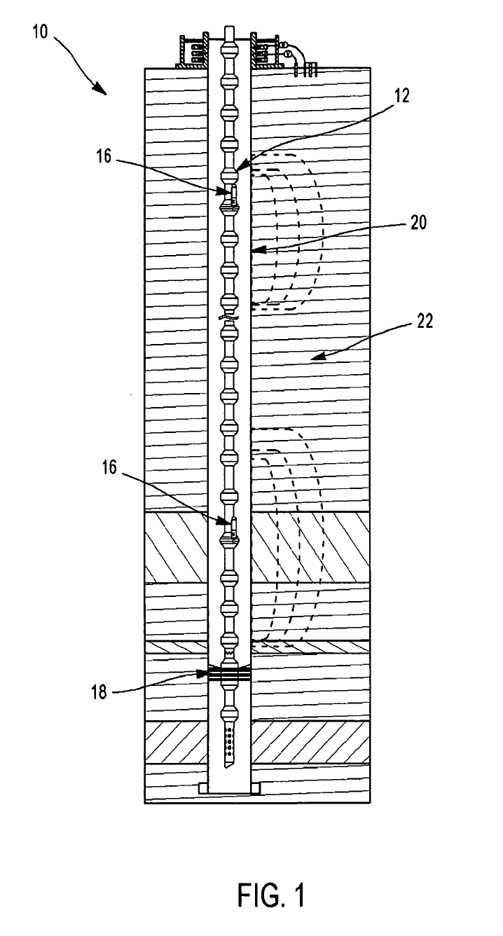

FIG. 1 schematically depicts a tool string (10) extending downhole for reservoir characterization and measurement in accordance with one or more embodiments of the present disclosure. Depending on the application, the tool string (10) may be a drilling string, a string of completion tools, a production string, a workover string, or any other string of tools to be sent downhole to investigate a surrounding formation. Generally, when a hole is drilled into the earth, the walls of the surrounding formation may be lined with a string of casing (20) to prevent the wellbore from collapsing and to (selectively) isolate the formation from the bore of the drilled well. Casing string (20) may be metallic or any another material (e.g., composite) that is potentially more electrically conductive than the surrounding formation (22). The surrounding formation (22) may be comprised of different layers of rock, sand, and clay that may contain fluids, i.e., liquids or gases. In an oil well, tools may be located upon the string of drill pipe that extends downhole at the desired depth for taking measurements. Similarly, in completed wells, measurement devices may be located upon a string of production tubing extending through the cased wellbore across various zones of the formation.

FIG. 1 also shows a bi-directional wireless telemetry system for wireless communication between the surface and downhole tools, or between two or more locations downhole. In one embodiment, the electromagnetic wireless telemetry system may operate using Extremely Low Frequency EM signal transmission and modulation. The electromagnetic wireless telemetry system typically operates in the frequency range of 0.25 to 8 Hz and may target a range of 3000 m in onshore and offshore environments. As shown, the wireless telemetry system includes a downhole antenna (12). The downhole antenna may include an electrode (14) and may act as a current source when placed downhole with other downhole tools, e.g., packer (18), valves, samplers, gauges, sensors, etc. In FIG. 1, one or more repeaters (16) may be used to extend the range of transmission of the EM signal down the drill pipe to the antenna (12). The EM signal may carry messages to be communicated to and from the downhole tools.

More specifically, communication using the electromagnetic wireless telemetry system may be enabled by the injection of a modulated current into the formation via an electrical dipole. The voltage difference inducted by this circulating current may be measured along the casing walls by the repeater or between the wellhead and a remote stake at the surface. This voltage difference may be demodulated (e.g., at the surface) to extract the information from the signal. The communication itself may be based on a phase modulation of the injected current.

In one or more embodiments of the present disclosure, the wireless telemetry system, whether electromagnetic or acoustic, may be used to receive commands directed to a downhole valve control tool (or any other downhole tool) and transfer the commands to the valve control tool. The downhole valve control tool may be configured to control the position of tester and circulating valves that control fluid flow in the drill pipe. More specifically, the wireless telemetry system may be used to provide dual control of the downhole tester and circulating valves, where one way to control the valves is directly through the valve control tool and the other is through commands directed to the valve control tool via the wireless telemetry system.

Commands from the surface may be sent to the valve control tool (or any other downhole tool) via the wireless telemetry system in multiple ways. For example, in one or more embodiments of the present disclosure, commands may be sent wirelessly from the surface. In this type of communication, electromagnetic (EM) waves may be propagated from the surface to far distances with little attenuation at low frequency. The wireless communication range may be longer for higher formation resistivity. The EM waves may be communicated wirelessly from the surface directly to the downhole wirelessly telemetry system, which includes an electronic modem with a receiver configured to receive and demodulate the EM signal. The command received by the electronic modem of the wireless telemetry system may then be transferred to the valve control tool via wires.

Alternatively, in one or more embodiments, an EM signal may be sent wirelessly from the surface to a repeater in the drill string. The repeater may then relay the message via zero or more additional repeaters until the signal reaches the electronic modem of the wireless telemetry system. This type of communication can be useful when formation resistivity is low, as the signal attenuation increases and the telemetry range decreases. In this scenario, the use of repeaters may be necessary to reach the downhole wireless telemetry system.

Alternatively, in one or more embodiments, modulated acoustic signals may be sent wirelessly from the surface, propagating along the drill string at a predetermined frequency and data bit rate. The acoustic propagation may be received by the downhole telemetry module via zero or more repeaters, which may include an acoustic element, such as a piezoelectric element or magnetorestrictive element for transforming the acoustic signal into a corresponding analog electrical signal. This analog signal is demodulated from its carrier frequency, then decoded to produce a digital bit stream which may be represented electrically as, for example, an RS585 digital signal, although physically represented by differential voltages. The digital signal may then be transmitted via hardwire between the telemetry module, interface and downhole tool.

As described above, a command received by the wireless telemetry system (or a downhole tool that is part of the wireless telemetry system) that is directed to the valve control tool may be transferred to the valve control tool via wires. In one or more embodiments disclosed herein, the wires that facilitate this transfer are part of an interface that is designed to operatively connect the valve control tool and the wireless telemetry system and facilitate communication between the aforementioned downhole tool, for example, to provide dual control of the tester and circulating valves.

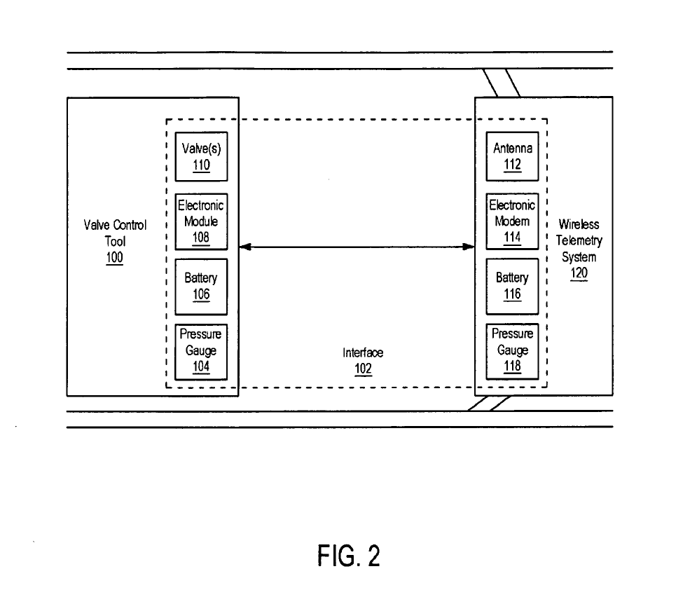

FIG. 2 schematically depicts an interface (102) in accordance with one or more embodiments of the present disclosure. Specifically, the interface (102) facilitates communication between a downhole wireless telemetry system (120) such as that described above in FIG. 1 (or a downhole tool that is part of the wireless telemetry system) and a downhole valve control tool (100). More specifically, the interface (102) may be an electromechanical interface between the downhole wireless telemetry system (120) and a downhole valve control tool (100) and may include a standard thread coupling junction (e.g., a PH6) on the mechanical side and a two-wire serial communication line (e.g., RS 485) on the electrical side. The two-wire serial communication line of the interface (102) are directed from the wireless telemetry system (120) to the downhole valve control tool (100). Each of the components on both sides of the interface (102) is described below.

In FIG. 2, the interface (102) is conceptually drawn to include components associated with the downhole wireless telemetry system (120) and the downhole valve control tool (100). The side interfacing with the wireless telemetry system (120) may include the interface components for the wireless telemetry system (120) and the side interfacing with the valve control tool (100) may include the interface components for the valve control tool (100). Those skilled in the art will appreciate that the interface components shown on either side of the interface (102) may be components of the corresponding downhole tool itself, which may be modified in some way for the interface (102) or that are used by the interface (102). Alternatively, in one or more embodiments disclosed herein, the interface (102) may be a separate electromechanical interface situated between the downhole tools.

Specifically, the interface (102) may include, on the wireless telemetry system side, an antenna (112), an electronic module (114), a battery (116) and a pressure gauge (118). In an electromagnetic wireless telemetry system arrangement, the antenna (112) may be located on a pipe surrounded by a casing in the wellbore and may include a power source for injecting a current across an insulated section of the pipe (i.e., an insulated gap). The antenna (112) may also include an electrode for conducting the current from the pipe to the casing and another insulated section of the pipe arranged to operate with the electrode to direct a path for flow of the current. The antenna may be used to measure a voltage induced by the current flowing along the pipe. Those skilled in the art will appreciate that various different types of antennas may be used as antenna (112), and as such, may be modified for various types of wireless telemetry systems. For example, the antenna may be a toroidal antenna.

The electronic module (114) is a module and a modem that may include a receiver board, a transmitter board, and an interface to the pressure gauge of the downhole tool. In addition, the electronic module (114) may include a microprocessor and may include memory. The receiver board may acquire the voltage measurement on the antenna. The microprocessor of the electronic module (114) may then filter, demodulate, and decode the incoming signal. At this stage, the incoming signal is determined to be either a wireless telemetry command, such as EM or acoustic, or a command directed to the valve control tool (i.e., the equivalent of a pressure pulse command). Upon reception of a valid command for the valve control tool, the electronic module (114) sends the command over the interface serial communication wires to the electronic module (108) of the valve control tool (100). The transmitter board of the electronic module (114) generates a current across the antenna to send messages, such as the valve position status, to the surface or to the next repeater in the drill string. The battery (116) provides energy to the wireless telemetry system electronic equipment.

On the valve control tool side, the interface (102) may include valve(s) (110), an electronic module (108), a battery (106), and a pressure gauge (104). In one or more embodiments disclosed herein, the electronic module (108) on the valve control tool side is operatively connected to the electronic module (114) on the wireless telemetry system side via the interface (102). More specifically, the electronic module (108) may be configured to receive the decoded pressure pulse command from the electronic module (114) of the wireless telemetry system and to send feedback from the valve control tool to the electronic module (114) of the wireless telemetry system. The electronic module (108) on the valve control tool side also includes a microprocessor and may include memory.

The pressure gauge (104) is a sensor that may be configured to detect the pressure level or pressure command to shift the position of the tester and circulating valves (110). The battery (106) provides energy to the electronic equipment of the valve control tool. The valves (110) shift between an open and a closed position to control fluid flow in the drill pipe. The serial wires of the interface (102) may be directly connected to the valves (110), such that the pressure gauge can interpret the pressure pulse command, and the interface (102) may then shift the position of the valves according to the received command. Alternatively, the interface wires may connect to electronic equipment of the valve control tool, which in turn may control the position of the valves.

As described above, the components shown in the interface (102) of FIG. 2 may be components that are part of the downhole electronic equipment that forms the wireless telemetry system and the valve control tool. For example, while the electronic module (108) of the valve control tool and the electronic module (114) of the wireless telemetry system are shown as part of the interface (102), the interface (102) may operatively connect these two modules which may be a part of the respective equipment for each of the downhole tools. That is, an electronic module may already exist as part of the equipment for both tools and provide some functionality for each tool. However, to implement the interface (102) between the two downhole telemetry modules, the electronic module on the wireless telemetry system side may be modified to include functionality to demodulate and decode commands to determine the commands directed to the valve control tool, and the electronic module (108) on the valve control tool side may be modified to accept commands from the electronic module (114) of the wireless telemetry system. Other components, such as the valves (110), shown within the interface (102) in FIG. 2 may also be part of the downhole tool electronic equipment.

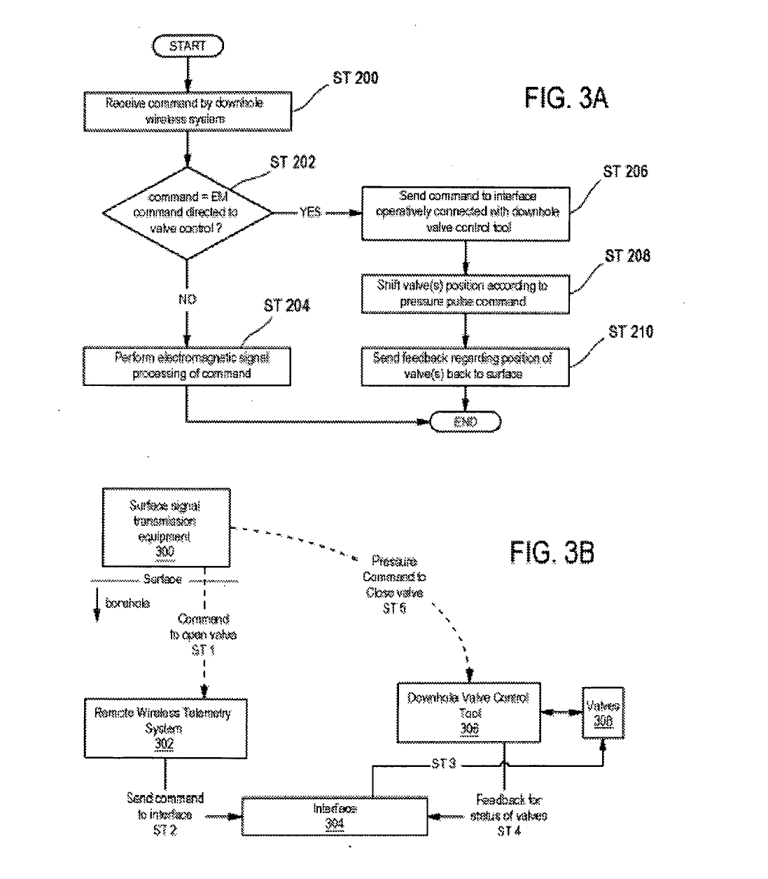

FIG. 3A shows a flow chart for controlling downhole valves in accordance with one or more embodiments of the present disclosure. While the various steps in the flow chart of FIG. 3A are presented and described sequentially, one of ordinary skill will appreciate that some or all of the steps may be executed in different orders, modified for various telemetry systems, combined or omitted, and some or all of the steps may be executed in parallel. In addition, steps such as store acknowledgements have been omitted to simplify the presentation.

Initially, a command is received by the downhole wireless telemetry system (ST 200). The command is transmitted from the surface by a surface transmitter using an electromagnetic or acoustic signal. Next, a determination is made as to whether the command is a wireless command directed toward the downhole valve control tool, a pressure pulse command directed toward the downhole valve control tool, or another type of wireless command for the wireless telemetry system (ST 202). Specifically, the incoming signal is filtered, demodulated, and decoded to determine whether the signal is a wireless command intended for the wireless telemetry system to perform an action unrelated to controlling of the valves, or a valid command intended for the valve control tool. If the command is a wireless command not directed to the valve control tool (ST 202), then the wireless telemetry system performs signal processing of the command, where the wireless command may subsequently be used to communicate with other downhole testing tools (ST 204).

Alternatively, in one or more embodiments of the present disclosure, a command transmitted to the remote wireless telemetry system may be a modulated electromagnetic, acoustic or pressure pulse command directed to the valve control tool. Thus, upon receipt of a valid command directed to the valve control tool (ST 202), the wireless telemetry system sends the command to the interface operatively connecting the wireless telemetry system and the downhole valve control tool (ST 206). More specifically, the decoded command directed to the valve control tool is sent to the valve control tool via the embedded electromechanical interface that facilitates communication between the wireless telemetry system and the valve control tool. The electronics module that is part of the interface on the valve control tool side receives the command. The electronics module on the downhole valve control tool side of the interface and the pressure gauge are subsequently used to detect and interpret the pressure pulse command and shift the position of the valve(s) downhole from open to closed or closed to open (ST 208). The shift in the valve position can be used to control the fluid flow in the wellbore.

At this stage, a feedback mechanism enabled via the interface may be used to send the status of the valve position to the surface (ST 210). More specifically, the transmitter board in the electronics modem/module of the wireless telemetry system generates a current across the antenna to wirelessly send messages, such as the status of the tester and circulating valves, from the valve control tool to the surface. The valve position status indicates whether the valve is open or closed after the pressure pulse command is executed.

In one or more embodiments of the present disclosure, feedback may include, in addition to valve position status after a pressure pulse command is sent to the wireless telemetry system, the status of downhole tools, acknowledgement of received pressure pulse commands, sending of the pressure profile recorded by the wireless telemetry system to verify that the pressure profile is correct, acknowledgement of a received EM command, any combination thereof, or any other suitable feedback. Thus, embodiments of the present disclosure provide a direct feedback mechanism that obtains feedback from the downhole valve control tool and sends the feedback via the wireless telemetry system to the surface.

FIG. 3B schematically depicts an example of the dual control of downhole testing and circular valves in accordance with one or more embodiments of the present disclosure. Surface signal transmission equipment (300) is equipment located on the surface, or rig floor, and is used to send signals downhole. The surface signal transmission equipment (300) may be used to send wireless communication signals to the wireless telemetry system (302) and to send pressure commands directly to the downhole valve control tool (306).

Initially, a command to open a downhole tester or circulating valve may be sent from the surface signal transmission equipment (300) to the downhole wireless telemetry system (302) (ST 1). As the command in this example is a pressure command directed to the downhole valve control tool, the downhole wireless telemetry system (302) then sends the command to the interface (304) (ST 2). Those skilled in the art will appreciate that the wireless telemetry system includes functionality (i.e., processing power) to demodulate and decode the incoming signal to determine whether the command received is an EM command or a command directed to the valve control tool.

In one or more embodiments of the present disclosure, the electronics module of the interface is operatively connected to the valves (308). In ST 3, the interface (304) changes the position of the valves (308) from closed to open according to the received command. Feedback regarding the open status of the valves (308) is then sent from the valve control tool (306) to the surface through the wireless telemetry system (302) (ST 4). Subsequently, a pressure pulse command to close the valve is sent directly from the surface to the downhole valve control tool (306) in the traditional manner (ST 5).

Thus, according to the example described above, embodiments of the present disclosure may provide a redundant mechanism to operate the tester and circulating valves downhole. The valves may be operated either by pressure commands sent directly from the surface to the valve control tool located downhole, and/or using wireless EM or acoustic commands via the remote wireless telemetry system which are then used to control the valves via an interface as described above in FIG. 2. In one or more embodiments, both types of commands are used dynamically in a manner that allows one valve to be opened with a direct pressure pulse to the valve control tool and closed with an EM command sent via the wireless telemetry system and another valve to be opened with an EM command and closed with a direct pressure command.

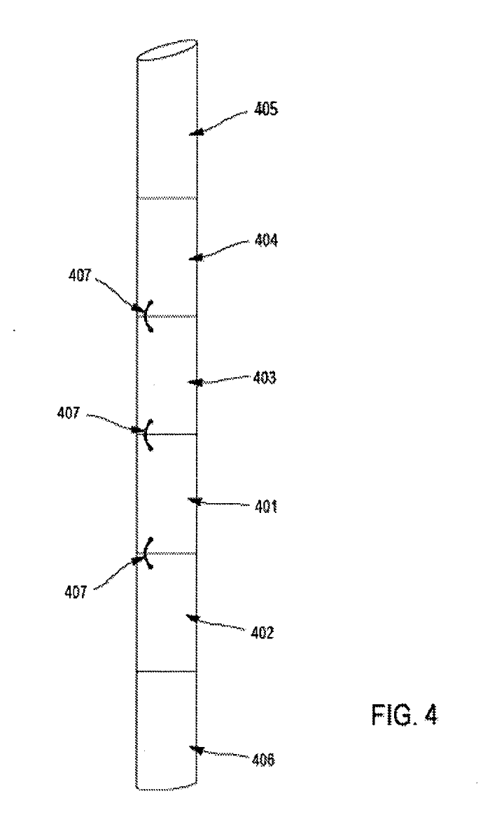

FIG. 4 depicts a schematic illustration of a drill stem string (405) wherein one or more downhole tools (402, 403, 404, 406) are capable of being controlled by an interface with a single telemetry module (401). The telemetry module (401) communicates with the surface, using repeaters if required. The telemetry module (401) is adapted to relay a signal/information/command to and from the one or more downhole tools (402, 403, 404, 406) in the drill string (405). Examples of such downhole tools (402, 403, 404, 406) can include a downhole control valve (404), as described hereinbefore, but may also include a downhole packer (402) used to isolate various zones in the well bore. In addition, the one or more downhole tools (402, 403, 404, 406) may be a downhole sampling tool (403) used to take samples of hydrocarbons downhole. Moreover, the telemetry module (401) may be in communication with a downhole firing head (406) used to detonate downhole guns. In essence, one having skill in the art can imagine that the telemetry module (401) may be connected to any downhole tool capable of receiving an electronic signal. In most instances, the downhole tool capable of receiving an electronic signal from the telemetry module (401) would likely contain onboard electronics. It should be noted that although one telemetry module is shown for controlling the one or more downhole tools (402,403,404), multiple telemetry modules may be implemented.

The above described downhole valves, packers, sampler tools, firing heads, and the like, are well known and available in one form or another in the market place as standalone tools, i.e. operable without an interface with a downhole transceiver. When operated as standalone tools, the signal to command these downhole tools may be the low level pressure pulse signals as mentioned above; however, in one or more embodiments of the present disclosure a system and method is provided to enable the advantages of EM communication with the one or more downhole tools (402, 403, 404, 406).

A technical problem encountered when connecting two downhole tools which require electrical communication between one another is the way in which to form an electrical connection between the electronic boards of each downhole tool that can withstand the hostile downhole environment, and be rotated. In general, downhole tools are made up of tubular components which are connected to each other by means of a rotating thread. The rotation between downhole tools with respect to each other when assembling makes the use of electrical connections challenging at least.

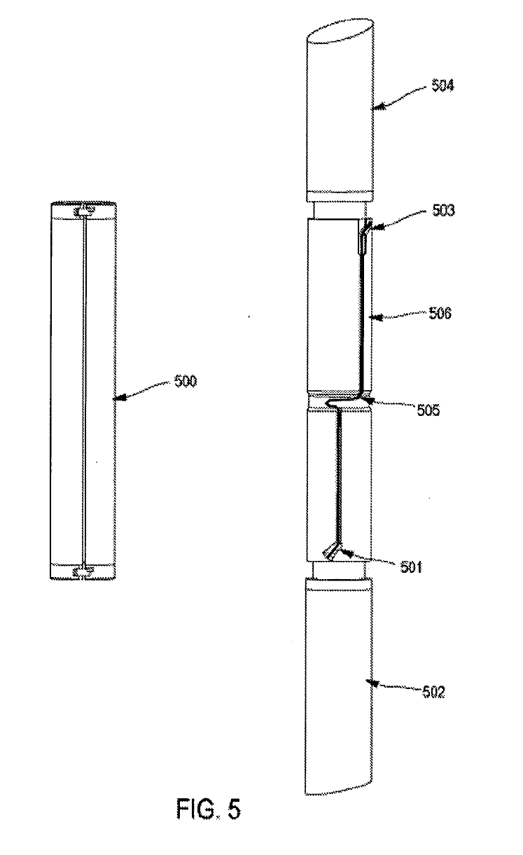

FIG. 4 (and FIG. 5, described hereinafter) illustrate a way to form an electrical connection between various downhole tools. The downhole tools may be connected to the drill string at the rig floor, or beforehand, by screwing the bottom thread of one tool (e.g., 401) into the top thread, of another tool (e.g., 402). After the mechanical connection has been made, the electrical connection can be made with the use of wires (407). As such, a multitude of downhole tools may be connected to one another, mechanically and electrically, using standard threads and external wiring.

FIG. 5 depicts a model of the interface connecting a downhole tool (504) to a downhole telemetry module (504) in accordance with one or more embodiments of the present disclosure. A protective cover (500) is also shown for, among other purposes, protecting the signal wire (506) running between another downhole telemetry module (502) and the downhole tool (504).

In operation, after the tools have been mechanically connected at or near the rig floor, an electrical connection can be made with the signal wire (506). The top portion, or sub, of the downhole telemetry module (502) comprises a pressure bulkhead connector (501), and the bottom portion, or sub, of the downhole tool (504) also comprises a pressure bulkhead connector (503). The pressure bulkhead connectors (501, 503) are capable of bringing an electrical signal from inside the tool to outside the tool. The electrical connection is made between the two tools by connecting one or more signal wires (506) between the two pressure bulkhead connectors (501, 503) of the two tools (502, 504).

In an alternative embodiment (not shown), a downhole communication system with one wire could be envisioned where the communication channel is of the one wire communication type using the mass of the system as a return. In this case only one electrical wire between the two tools would be needed. However, more likely a two wire communication channel, e.g. RS232 or RS485 would be used. In this case, per communication channel two electrical wires are needed, each with its own bulkheads or using multi-connection bulkheads. Subsequently one can envision multiple wire communications channels. Furthermore, one could imagine there are more than one communication channel between the tools.

After the electrical connections are made, the electrical connection should be protected from damage when running in and out of the well. This can be done by placing the wires in recessed grooves, and subsequently protecting the wires with the use of a cover (500).

Embodiments of the present disclosure provide a system and method for sending commands from the surface to a downhole tool, such as a downhole valve control tool, via a wireless telemetry system. The commands from the surface may be sent to the downhole tool wirelessly from the surface to the wireless remote telemetry system and then through wires to the downhole tool, or wirelessly to a first repeater in the drill pipe and then via wires to intermediate repeaters as necessary until the command reaches the a wireless telemetry system. The command is then transferred to the downhole tool via wires of the interface described in embodiments above. More specifically, embodiments disclosed herein provide a dual wireless remote control system that uses either low frequency EM transmission signals or acoustic propagation, and fluid pressure pulse commands to control various downhole tools, such as tester and circulating valves. In addition, embodiments of the present disclosure provide a feedback mechanism associated with the wireless system that facilitates feedback to be sent from the downhole tool to the surface via the wireless remote telemetry system.

While the present invention has been described with respect to a limited number of embodiments, those skilled in the art, having benefit of this disclosure, will appreciate that other embodiments can be devised which do not depart from the scope of the present disclosure. Accordingly, the scope of the present invention should be limited only by the attached claims.

What is claimed is:

1. A downhole communication system for communicating between a downhole location within a wellbore and a surface location, the system comprising:
a first telemetry module connected to a string and positioned downhole within the wellbore, the first telemetry module configured to receive communication signals via at least one of acoustic propagation and low frequency electromagnetic transmission;
a second telemetry module connected to the string and positioned downhole within the wellbore, the second telemetry module configured to receive communication signals via fluid pressure pulse commands;
a downhole tool operatively connected to the string; and
an interface electrically connecting the downhole tool to the first and second telemetry modules, and selectively relaying digital communication signals between the downhole tool and at least one of the first and second telemetry modules.

2. The system according to claim 1, further comprising a second downhole tool operatively connected to the string and electrically connected to the interface.

3. The system according to claim 1, wherein the downhole tool is selected from a group consisting of: a tester valve, a circulating valve, a sampler, a packer, and a perforating gun.

4. The system according to claim 1, further comprising at least one repeater connected to the string and configured to communicate using acoustic propagation or low frequency electromagnetic transmission.

5. The system according to claim 1, wherein at least one of the first telemetry module, the second telemetry module and the interface are battery powered.

6. The system according to claim 1, wherein the digital communication signals comprise at least one message selected from the group consisting of a downhole tool status information, valve position status, acknowledgment of a received pressure pulse command, and a pressure profile.

7. The system according to claim 1, wherein the first telemetry module is part of a wireless remote telemetry system.

8. The system according to claim 1, wherein the interface is embedded within at least one of the first and second telemetry modules.

9. The system according to claim 1, wherein the second telemetry module is a valve control tool capable of receiving fluid pressure pulse commands directly from a surface signal transmitter.

10. The system according to claim 9, wherein the valves comprise a tester valve and a circulating valve that are used to control fluid flow in the wellbore.

11. The system according to claim 9, wherein
a first position change in the valve control tool is performed by a first command sent in the form of a low frequency electromagnetic transmission to the first telemetry module, and transferred to the valve control tool via the interface; and
a second position change in the valve control tool is performed by a second command sent in the form of a fluid pressure pulse from the surface signal transmitter to the valve control tool.

12. An interface connected to a string and positioned downhole within a wellbore, the interface being configured to facilitate communication between a downhole location within a wellbore and a surface location, wherein the interface comprises:
an electronic module electrically connecting a downhole tool to a first telemetry module and a second telemetry module; the first telemetry module configured to receive communication signals via at least one of acoustic propagation and low frequency electromagnetic transmission, and the second telemetry module configured to receive communication signals via fluid pressure pulse commands;
wherein the electronic module comprises at least one microcontroller executing instructions to selectively relay digital communication signals from at least one of the first telemetry module and second telemetry module to the downhole tool.

13. The interface according to claim 12, wherein'the interface comprises:
a coupling junction mechanically connecting the first and second telemetry modules,
a two wire serial communication line electrically connecting the first and second electronic modules; and
a cover protecting the serial wire.

14. A method for communicating between a downhole location within a wellbore and a surface location, the method comprising the steps of:
initiating a communication signal at a surface location, the communication signal comprising at least one of a fluid pressure pulse command, a low frequency electromagnetic transmission, and an acoustic propagation;
receiving the communication signal at a first telemetry module or a second telemetry module connected to a string and positioned downhole within the wellbore, wherein the first telemetry module is configured to receive communication signals via at least one of acoustic propagation and low frequency electromagnetic transmission, and the second telemetry module is configured to receive communication signals via fluid pressure pulse commands;
decoding the communication signal at the first telemetry module or second telemetry module to create a digital communication signal; and
selectively relaying the digital communication signal at an interface between a downhole tool and at least one of the first and second telemetry modules.

15. The method according to claim 14, wherein the second telemetry module is a valve control tool capable of receiving fluid pressure pulse commands directly from a surface signal transmitter.

16. The method according to claim 15, wherein the method further comprises:
changing the valve control tool into a first position by sending a first command in the form of a low frequency electromagnetic transmission to the first telemetry module;
transferring the first commend to the valve control tool via the interface; and
changing the valve control tool into a second position by sending a second command in the form of a fluid pressure pulse from the surface signal transmitter to the valve control tool.

17. The method of claim 14, wherein the interface is embedded within at least one of the first and second telemetry modules.
